(19) United States
(12) Patent Application Publication
(10) Pub. No.: US 2007/0271223 A1
(43) Pub. Date: Nov. 22, 2007

(54) Method and implementation of reliable consensus feature selection in biomedical discovery

(76) Inventors: John Xiaoming Zhang, Needham, MA (US); Jun Luo, Arlington, MA (US); An Cao Carlson, Billerica, MA (US); Eric Yang Wang, Lexington, MA (US)

Correspondence Address: BURNS & LEVINSON, LLP, 125 SUMMER STREET, BOSTON, MA, 02110, US

(21) Appl. No.: 11/800,478

(22) Filed: May 4, 2007

Related U.S. Application Data
(60) Provisional application No. 60/801,348, filed on May 18, 2006.

(51) Int. Cl. G06F 17/30

(52) U.S. Cl. 707/2

(57) ABSTRACT

Process and apparatus for combining multiple processes for choosing features such as biomarkers in statistical data using consensus voting among the multiple processes and their chosen features.

### CROSS-REFERENCE TO RELATED APPLICATIONS

This application incorporates by reference and claims priority of Provisional Patent Application No. 60/801,348, filed May 18, 2006 by the three of the four inventors hereof, entitled “Method and Implementation of Reliable Feature Selection in Biomedical Discovery.”

### FEDERALLY SPONSORED RESEARCH/DEVELOPMENT

Some of the implementation of the invention disclosed here was performed under the United States Department of Defense (U.S. Air Force), SBIR/STTR Program No. FA8650-06-C-6640, the U.S. Army Center for Environmental Health Research contract No. W81XWH-06-0139, and the U.S. National Science Foundation, SBIR/STTR Program No. 011-0539056.

### FIELD OF THE INVENTION

This invention relates generally to the field of data mining, pattern recognition, statistical learning, and dimensionality reduction that can be applied to many machine-learning and statistical analysis applications such as biomarker discovery, clinical genomics, toxicogenomics, pharmacogenomics, biomedical data analysis, chemical finger-print, image processing, text feature extraction, speech recognition, marketing and sales data analysis, internet web data analysis, environmental monitoring, health safety, medical diagnosis and prognosis. Although the procedure of the present invention is described as applied to biomedical discovery, the method can be used for increasing reliability and robustness of results in any type of feature selection problems.

### BACKGROUND OF THE INVENTION

In recent years, feature selection processes based on biological methods such as fold-change, statistical methods such as using t-test p-value, machine-learning techniques such as support vector machine, and information theory methods such as Gini impurity, have been applied to the field of biomedical discovery and led to many new developments. However, due to the exploratory nature of the research and lack of strict industrial standards, many inconsistent or even conflicting results have been reported. Researchers come to an agreement that there is no best analysis algorithm for doing biomedical discovery, or more specifically, biomarker discovery [1].

Biomarkers can be classified into three categories: clinically measured markers (e.g., weight), imaging markers (e.g., labeled antibodies), and molecular markers (e.g., DNA, RNA, protein, metabolites, etc). As new and mature technologies of genomics and proteomics emerging, the molecular biomarkers are becoming more and more important in biological discovery, drug development and health care. Extensive efforts are given to find biomarkers for disease detection, typing, and choice of therapy for individual patient. Biomarkers are not only useful for diagnosis and prognosis of many diseases, but also for understanding the pathomechanism, which is a basis for development of therapeutics. Successful and effective identification of biomarkers can greatly accelerate the new drug development process for unmet medical needs. With the combination of therapeutics with diagnostics and prognosis, biomarker identification will also enhance the quality of current medical treatments, thus play an important role in the use of pharmacogenetics, pharmacogenomics and pharmacoproteomics.

The identification and validation of a biomarker has been extremely time-consuming and costly. In an era when huge amount of genomics and proteomics information becomes available, the challenge is how to discover and select the most robust and reliable features as promising candidate molecular biomarkers, instead of validating all possible features [2]. The expectation is that with modern bioinformatics technologies, the speed, accuracy, and effectiveness of identifying potential biomarkers out of thousands to hundred of thousands of features such as genes, proteins, and metabolites and pathways will be dramatically accelerated. To date, however, even with the rapid development of advanced technologies, the rate of successful transferring biomarkers to market remains very low.

The reality of molecular biomarker discovery requires feature selection to reduce the feature set to a manageable number of genes or proteins [3]. Feature selection, also known as subset selection, feature extraction or variable selection, is a process commonly used in machine learning, wherein a subset of the features available from the data are selected so that follow-up processes on the subset become computationally or practically feasible[4],[5]. In biomarker discovery, such a feature can itself be a gene biomarker, protein biomarker, or metabolite biomarker. In addition, combined features, or pattern, can also serve as biomarkers.

Another reason feature selection is important in biomarker discovery is based on the innate characteristics of high through-put “omics” data. Due to the high cost of experimental replicates, in a typical “omics” data set, limited data samples coupled with a large number of features are very common, which leads to the so-called “curse of dimensionality”. Small sample size coupled with high-dimensional feature space poses a significant obstacle in machine learning. In particular, as the dimensionality increases, inferences drawn by a machine learning algorithm require extrapolation, as the points in the training set are too sparse to be able to apply interpolation. Such extrapolation in turn introduces uncertainty and reduces accuracy. Dimensionality reduction techniques, such as feature selection, are typically applied in such cases to avoid the “curse of dimensionality”.

However, feature selection suffers from lack of numerical validation methods, that is, there is no universal criterion to predetermine the quality of the features selected. Lack of consistency across platforms, or feature selection methods, is a common observation in the biomarkers research [1]. To evaluate the quality of features selected, it is a common practice that Venn diagram be used to see the percent of features overlapped among two or three lists of features selected using different methods. Such a practice does not give the ranks of the overlapped features. Most of the current applications apply supervised methods such as classification after feature selection and use the classification results to evaluate the selected features. This approach is prone to inconsistency because the evaluation results are usually dependent on the specific classification method(s) used in the evaluation process. Certain feature selection methods go well with some classification methods but not others. In addition, small sample size, a common observation in “omics” data set, also exposes feature selection results to biological sample bias, experimental variations or even human errors.

It is widely accepted that there is no single feature selection method which is universally better than any other methods in performing feature section for all data sets. There is also no a priori criterion which can determine which feature selection method is the best for a certain data set. Each individual feature selection method has its advantages and disadvantages. For example, T-test is a frequently used tool to select features by differentiating two or more classes. However, it does not apply when the number of samples is too small or the distribution is not normal. The ranges of applicability of many of these methods are not clearly understood. Thus, the reliability and confidence on applying existing methods on feature selection is limited. Several consensus methods [6], [7] have been developed for clustering and classification. However, systematic method for improving feature selection reliability has not been reported.

What is needed, therefore, is a method and implementation that integrates existing feature selection methods, synergizes the effectiveness of these methods through a consensus voting mechanism, and forms a more reliable and robust feature set. It is desirable that such a feature selection method to be a stand-alone method, that is, it should not have dependency on other supervised classification methods.

### BRIEF SUMMARY OF THE INVENTION

In accordance with this invention, a stand-alone feature selection method that integrates results from multiple feature selection methods is implemented. The degree of agreement among different feature selection methods serves as a criterion for the quality of features selected. The features are further ranked using a weighted ranking method, with higher rank typically reflecting a higher possibility of being a potential truly positive biomarker. As a result, the ranked features provide flexibility on how many features, and which features to choose for further research.

In one embodiment of the invention, a system for a stand-alone feature selection method comprises an Observation Input Module for receiving the input data, a Multiple Feature Selection Methods Module for individual member method process, a Consensus Voting and Ranking Module that integrates the feature sets selected by individual member methods, a Feature Output Module to output the selected features and an optional Database to store input and/or output data.

As used herein, “input data” refers to health data, clinical data or data generated from the experiments designed for molecular biomarker discovery or other chemical finger-print, including genomics data, proteomics data, metabolomics data, environmental, chemical data and the like. The data can be generated from, but not limited to, the following instruments such as MALDI-TOF, SELDI, HPLC, GC-MS, LC-MS, ESI-MS-MS, LC-MS-MS, NMR, FTIR, FT-Raman, TagMan, PCR, oligonucleotide microarray, cDNA microarray, and protein microarray, as well as from various clinical or chemical data. In some embodiments, input data values may be one or more of measured values, normalized values, background adjusted values, and statistical data derived from measured or calculated values (such as an average of a value over many samples). In some other embodiments, the input data can be time-course-based sequential data points.

In some embodiments, when the input sample size is limited, each member method uses resampling method to simulate perturbations of the data set, so as to assess the stability of the results with respect to sampling variability. The underlying assumption is that the more stable the results are with respect to the simulated perturbations, the more reliable these results are. The feature selected by each member method is an integration of the feature sets selected from many repeats of resamplings.

In some embodiments, there is an optional Pre-process Module before the input data are fed into the Multiple Feature Selection Methods Module.

In some embodiments, the Multiple Feature Selection Methods Module uses pre-assigned feature selection methods. In some other embodiments, such feature selection methods are selected in real-time through user inputs.

In another embodiment, the invention comprises an article of manufacture having a computer-readable medium with the computer-readable instructions embodied thereon for executing the methods described in the preceding paragraphs. In particular, the functionality of a method of the present invention may be embedded on a computer-readable medium, such as, but not limited to, a floppy disk, a hard disk, an optical disk, a magnetic tape, a PROM, an EPROM, CD, and DVD. The functionality of the method may be embedded on the computer-readable medium in any number of computer-readable instructions, or languages such as, for example, java, Python, FORTRAN, PASCAL, C, C++, C#, Tcl, BASIC, PERL, R, MatLab and assembly languages. Further, the computer-readable instructions can, for example, be written in a script, macro, or functionally embedded in commercially available software (such as, e.g., EXCEL, VISUAL BASIC, java or MatLab).

The foregoing and other objects, aspects, features, and advantages of the invention will become more apparent from the following descriptions.

### BRIEF DESCRIPTION OF THE DRAWINGS

FIG. 1 is a flow chart of a method for reliable feature selection in accordance with the present invention;

FIG. 2 is a flow chart similar to FIG. 1 with an optional step of data pre-processing, and an optional step of resampling in accordance with the present invention;

FIG. 3 is a partial flow chart showing detailed process of the consensus weighted voting in accordance with the present invention;

FIG. 4 is a block diagram of an implementation for reliable feature selection in accordance with the present invention;

FIG. 5 is a set of screenshots for an implementation for reliable feature selection in accordance with the present invention, with FIG. 5a a data/parameter input sheet and FIG. 5b an output file;

FIGS. 6a-6c are volcano plots showing gene selection relative to leukemia data, with FIG. 6a using the fold change method with small p-value cutoff, FIG. 6b using the T-test p-value method, and FIG. 6c showing the effect of using the present invention of consensus voting for reliable feature selection.

### DETAILED DESCRIPTION OF THE INVENTION

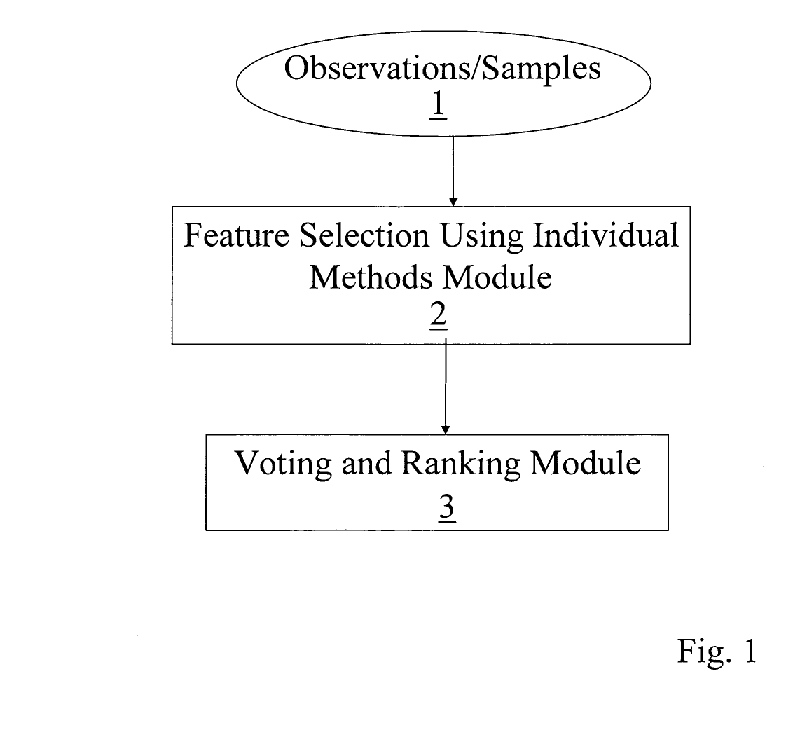

FIG. 1 illustrates a flow chart of a method of reliable feature selection. The observed data from 1 are fed into multiple feature selection methods in parallel. In 2, a set of feature selection methods are chosen typically based on their merits and the specific data set at hand. Such a method can be ANOVA test [8], B-Max [9], B-Min [9], B-scatter [9], Boosting Flexible Learning Ensembles with Dynamic Feature Selection [10], Brown Forsythe Statistic [8], CART [11], Chi Squared [9], Comb [9], Correlation Based [11], Fisher Score [12], Fold Change [13], Forward Substitution and Backward Elimination [14], Gene Shaving [15], Gini Impurity [16], Goodness-of-Fit [11], Information Gain [16], Kolmogorov-Smirnov Test [17], Kruskal-Wallis Test (H Test) [8], Margin based [18], MinMax [9], Nearest Shrunken Centroid [19], Partial Least Square [20], Random Forest [21], Signal to Noise Ratio [22], Significance Analysis of Microarray (SAM) [23], Support Vector Machine based [24], [26], T test [26], Transductive Support Vector Machine [27], Wavelet-based [28], Welch T [29], Wilcoxon Rank Sum [30], and the like. (References are given below.) More than one method should be used in order to take the advantage offered by this invention. The underlying assumption is that the more different methods agree on a feature, the more reliable the feature is. The selected features from each method are then integrated using the Consensus Voting and Ranking Module 3.

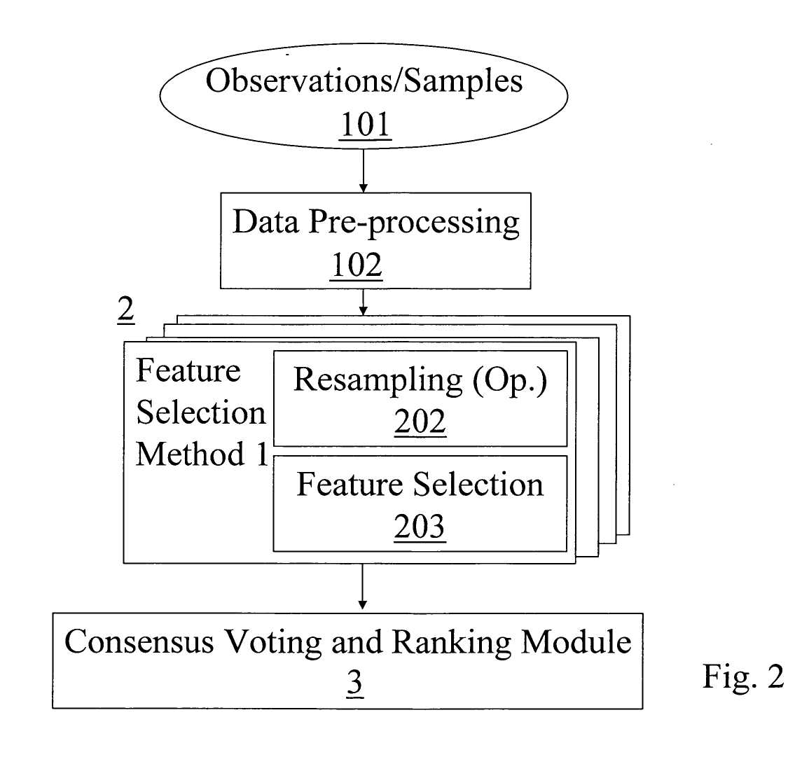

Optionally, the observations are pre-processed by 102 before passing into the feature selection module 2, as shown in FIG. 2. The data pre-processing step 102 is typically required when significant noise is presented in the data set. Common types of pre-processing include calibration, normalization, spatial and/or temporal alignment, background adjustments, and other noise filtering techniques.

Note that, as used herein, the terms “samples” and “observations” are used interchangeably, referring to related data from the inputs, which can be either pre-processed or not.

FIG. 2 also shows an optional resampling module 202. When the size of the observations is limited, the feature selection result may be biased to sample variation. Resampling is a method to assess the variance associated with the small sample size by perturbing the inputs. Depending on the problem at hand, the resampling can employ a bootstrap method, a bagging method, a jackknife method, a permutation test, or a cross validation method. In one embodiment, each feature selection method employs a resampling step independently, when limited sample size is presented.

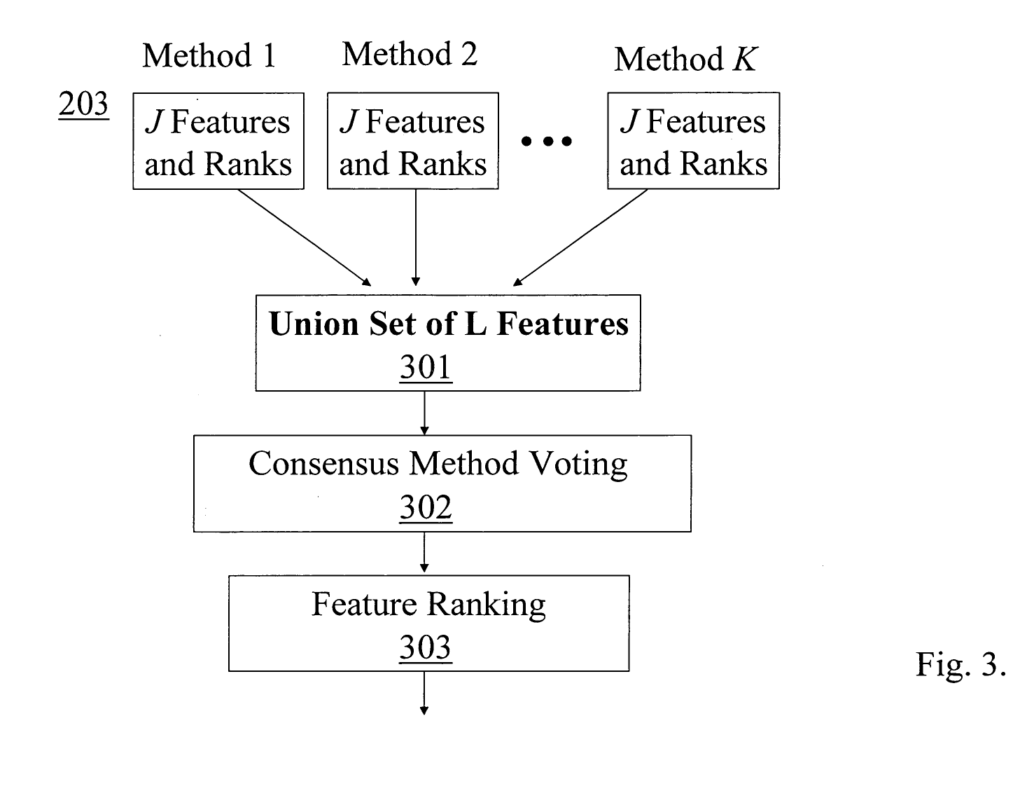

FIG. 3 details the process flow for reliable feature selection when the integration of results from different feature selection methods is used. In 203, each of the K feature selection methods M₁, M₂, . . . Mₖ, . . . , and M_{K} selects J features along with associated ranks, either using the optional resampling method or not, and sends them to 301. The numbers K and J can be user assigned or recommended by a software implementation. In a diagnostic context focusing on particular features such as biomarkers, J may be small, such 1 or 2. In a discovery context, J may be up to 100 or more. Current research suggests that 10-40 may be optimal for drug development. In some embodiments, J may be selected as a multiple, such as 2 or 3, of the number of features user is interested.

These K sets of feature lists with length J will form a combined feature list. In one embodiment as an example, a union feature set can be obtained from the K feature sets, which is consisted of L (>=J) unique features in these K sets.

For each feature in the union set, we obtain its rank, Rank, in each of the K sets. If a feature does not appear in one of the K sets, its rank is J+1 in that set.

For each feature in the union set, we obtain its frequency of occurrence, Freq (<=K), in all the K sets.

The final feature list is obtained using these ranks and frequencies.

The consensus method, which can also be considered “voting” for features by each feature selection method, uses a reliability assessment or a weight to each feature selection method. The rationale is that the more a method agrees with the other methods, the more reliable it is. Therefore, in 302, each method k is given a weight. Wk which is related to the ranks of the J features in set Mₖ and the frequency of occurrence of these features across the K sets.

For each feature in any of the K feature sets, we define a reverse rank as below.

RevRank=J+1−Rank for Rank<=J

RevRank=0 for Rank>J (1)

### If a feature is not present in a particular list, its reverse rank is 0. The top ranked feature in a list, Rank=1, will have reverse rank J. Thus, the higher the reverse rank value, the more important of this feature in the list.

We then define Method Score and Feature Score. Method Score is calculated for each method that will be used to compute the weights of all methods in consensus voting. Feature Score is calculated for each feature in the union set that will be used to rank all L features.

In one embodiment, a Method Score for Method k can be calculated as the sum of the products of frequency and the square root of reverse rank (or other mathematical functions of reverse rank) for each of the features in the feature list generated using Method k:

$$MethodScore ( k ) = {\sum }_{J} Freq \cdot \sqrt{RevRank} ( k = 1 , 2 , … , K ) \qquad ( 2 )$$

In another embodiment, a Method Score for Method k can be calculated as the sum of the quotients of frequency and the square root of rank (or other mathematical functions of rank) for each of the features in the feature list generated using Method k:

$$MethodScore ( k ) = {\sum }_{J} Freq / \sqrt{Rank} ( k = 1 , 2 , … , K ) \qquad ( 3 )$$

In one implementation, the weight for Method k is calculated as

$$Weight ( k ) = \frac{MethodScore ( k )}{{\sum }_{K} MethodScore ( k )} ( k = 1 , 2 , … , K ) \qquad ( 4 )$$

In another implementation, the weights are assigned by users according to their understanding or investigation of the samples and features.

In yet another implementation, the weights are assigned of equal weights.

In one embodiment, a Feature Score for feature 1 can be calculated as the sum of the products of weight for the kth method and the square root of reverse rank (or other mathematical functions of reverse rank) in the kth list for feature 1 in the union feature list over all K methods selected:

$$FeatureScore ( l ) = {\sum }_{K} Weight ( k ) \cdot \sqrt{RevRank ( l , k )} ( l = 1 , 2 , … , L ; k = 1 , 2 , … , K ) \qquad ( 5 )$$

In another embodiment, a Feature Score for feature 1 can be calculated as the sum of the products of weight for the kth method and the square root of rank (or other mathematical functions of reverse rank) in the kth list for feature 1 in the union feature list over all K feature methods selected:

$$FeatureScore ( l ) = {\sum }_{K} Weight ( k ) \cdot \sqrt{Rank ( l , k )} ( l = 1 , 2 , … , L ; k = 1 , 2 , … , K ) \qquad ( 6 )$$

The F features (F=<J) that have the highest feature score values are chosen as the final selected features, and are outputted to the next step. F is typically an integer assigned by user or some pre-determined criterion. The ranks of the F selected features are determined by the feature score values.

The rank of the features provides information about the importance of the features been selected. In biomarker discovery, focus should be directed to the top ranked features. The ranked result also reduces the chance of repeating the data analysis due to a change in investigation objectives. If a particular application needs to narrow down the number of selected features from F to F′, simply order the features by rank, and choose the F′ top ranked features.

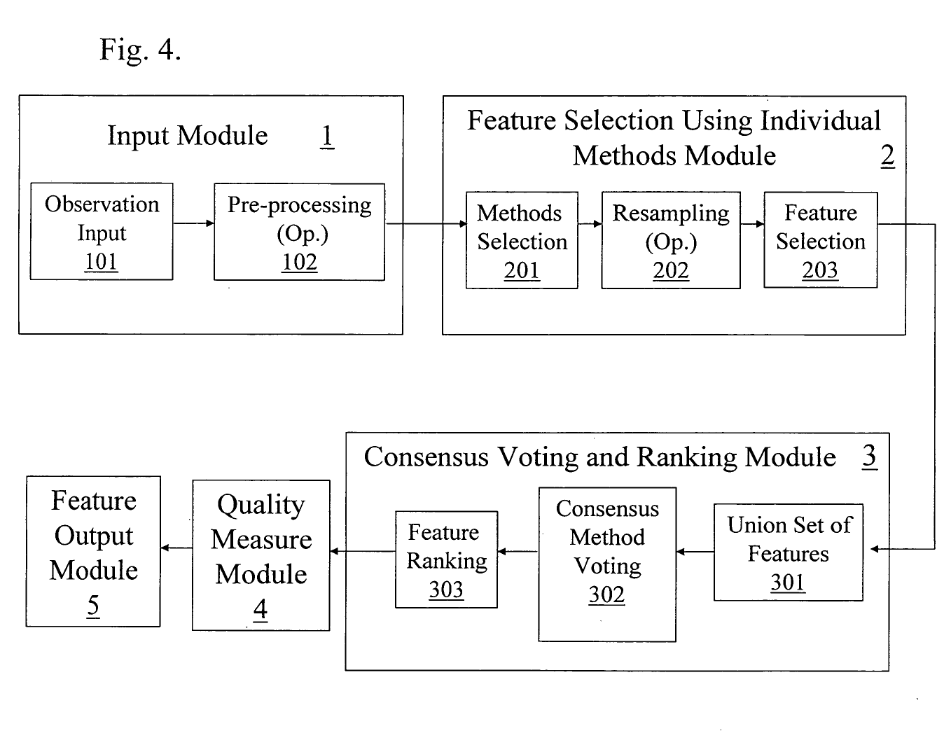

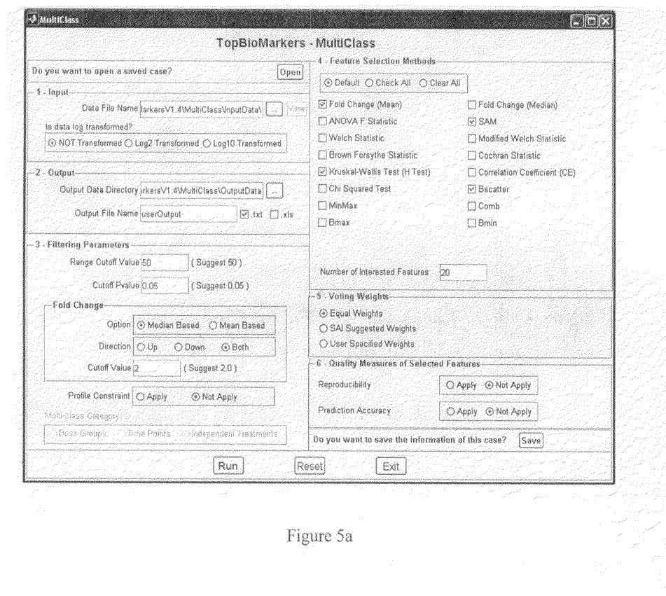

A computer-software implementation of the aforementioned method is deployed and illustrated in FIG. 4. Such a system includes an Input Module 1 which consists of an Observation Input sub-module 101 and an optional Pre-processing sub-module 102, Feature Selection Using Individual Methods Module 2, Consensus Voting and Ranking Module 3, Quality Measure Module 4, and Feature Output Module 5.

The Observation Input sub-module 101 can receive data directly from outside input and cache the data into computer memory or files. Alternatively, data can be saved first to a database, and be retrieved at a later time. The database facility can also store outputs from the Feature Output Module 5.

Sub-module 201 enables users to select specific feature selection methods which they see fit, or to use a set of default feature selection methods. Optional cross validation resampling technique can be applied by sub-module 202. Sub-module 203 applies the selected multiple feature selection methods and obtain multiple feature lists after the optional step 202.

The Consensus Voting and Ranking Module 3 consists of a Union Set of Features sub-module 301, a Consensus Method Voting sub-module 302 and a Feature Ranking sub-module 303. Final selected features are then sent to Quality Measure Module 4 to evaluate their quality, such as by reproducibility or prediction accuracy. (Reproducibility may be measured by the percentage of occurrence of the feature when each of the N samples is taken out of the data set. Prediction accuracy may be measured by taking one sample out of the data set, forming a training set of N−1 samples, and using it to predict the label of the removed sample, repeated N times.) The selected features are sent to Output Module 5 which directs the features to either outside applications or storage in the database facility for future use.

While there have been described what are presently believed to be the preferred embodiments of the invention, those skilled in the art will realize that various changes and modifications can be made to the invention without departing from the spirit of the invention, and it is intended to claim all such changes and modifications as fall within the scope of the invention.

### Screenshots of an Implementation and Explanation of Usage

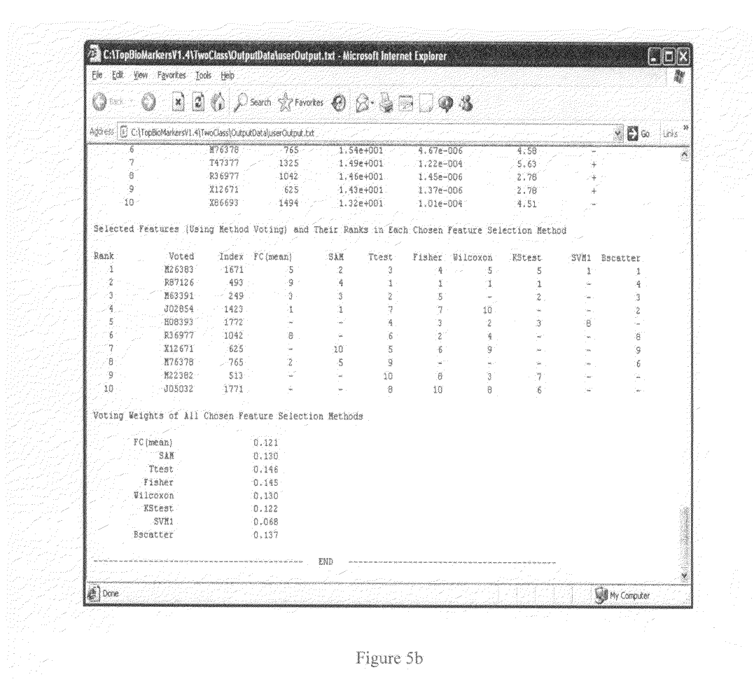

FIG. 5 shows two screenshots for an implementation of the method in a software product, TopBioMarkers™.

FIG. 5a is a data/parameter input sheet of the implementation using the invention for the reliable feature section from dataset with multiple classes. There are six sections in this input interface.

Section 1 specifies the input data file that contains the feature expression values of multiple classes and indicates whether this dataset has been log-transformed. This relates to the pre-processing in block 102 of FIG. 2 and sub-module 102 of FIG. 4.

Section 2 specifies the location of output file and the file format.

Section 3 is a list of pre-processing steps that filter out the obviously unwanted features. This list includes range cut-off, p-value cutoff, fold change cutoff, and profile constrain.

Section 4 lists a number of feature selection methods. The user can select any combination of these methods and obtain the ranked feature list using each method and the final ranked list with the consensus voting method. This Section also specifies the number of features of user's interest.

Section 5 specifies the choice of weights to the selected feature selection methods for consensus voting. It has three options: equal weights, an implementation of the weights described above, and any set of weights provided by users.

Section 6 provides two quality measures of the selected features, namely, reproducibility of the features selected and the prediction accuracy when the set of features is used to develop a predictive classification model.

FIG. 5b is a screenshot that shows the last part of the output file. The middle of the screenshot contains information on the ten features (in this case, genes or probes) obtained using the consensus method. The three columns on the left are the ranks, names, and indices (locations of the genes or features in the input data file) of the ten features selected. The eight columns on the right show the ranks of these ten features using each of the eight individual feature selection methods. In this case, these eights methods are: fold change, SAM, T-test, Fisher's test, Wilcoxon method, Kolmogrov-Smirnov test, Support Vector Machines, and Bscatter method.

The bottom portion of the screenshot shows the calculated weights for the eight feature selection methods used in the consensus voting.

### AN EXAMPLE

The example below is used to illustrate the application of the consensus voting method for reliable feature selection. This example shows the consensus voting between the relative importance of using reproducibility and classification accuracy as criteria in selecting features.

One method, the T test p-value method with a small fold change cutoff has been frequently used to select features which typically yields features with higher classification power, both sensitivity and specificity, usually preferred by statisticians.

Another method, the fold change method with small p-value cutoff has been proposed by MAQC Phase I(2006) [31] which typically yields high reproducibility of features selected across different sites and platforms, usually preferred by biologists.

An implementation of the consensus voting feature selection method is used in this example to reliably select features with both reproducibility and classification accuracy. The effectiveness of the invention is illustrated using a dataset from Golub et al [22].

This data set contains 47 acute lymphoblastic leukemia (ALL) samples and 25 acute myeloid leukemia (AML) samples. All those samples were measured using Affymetrix GeneChip, which contain 6,817 human genes. The objective is to select features (genes) that have high fold change values (strong reproducibility) and low p-values (strong differentiation between ALL and AML).

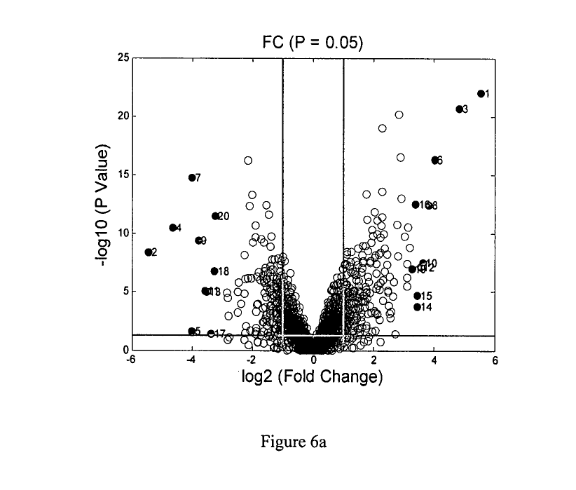

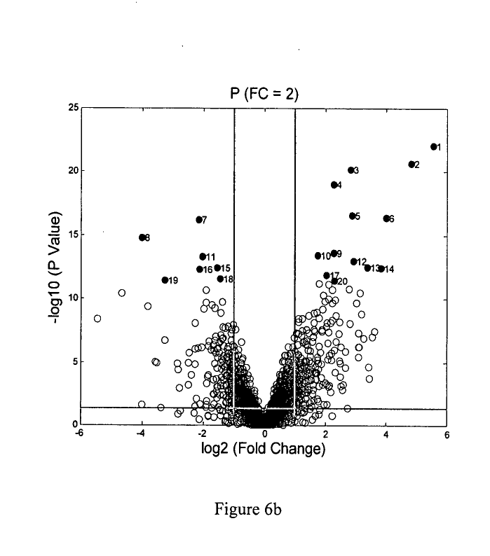

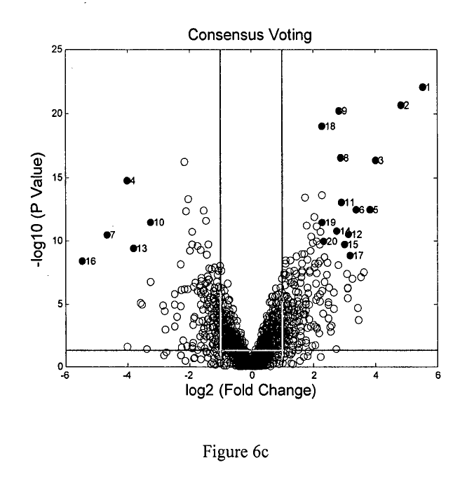

FIG. 6a shows a volcano plot using fold change as feature selection method with a p-value cut-off at p=0.05. The 20 solid points are the selected genes and the numbers are their corresponding ranks. This is a method proposed in MAQC Phase I study that can achieve higher reproducibility across different experiments. FIG. 6a indicates that the top genes are on the two extreme sides of the graph. The closer the genes to the middle at LOG2(Fold Change)=0, the lower their ranks. There are several genes with p-values very close to the cutoff value 0.05 in spite of that all the 20 selected genes have large fold changes. Thus, the selected 20 genes may have high reproducibility, but their classification accuracy may be relatively low.

FIG. 6b shows a volcano plot when T-test p-value method is used, with fold change cutoff FC=2, to select features. The higher the spots in FIG. 6b, the higher their ranks. The twenty selected features, represented by the solid spots, have very low p-value indicating of high classification accuracy. However, there are always several features very close to the two vertical lines FC=2 and FC=0.5 which indicating of relatively low reproducibility.

There has been a continuing debate as to which of these two feature selection methods should be used. To resolve the debate, we developed an implementation of the consensus feature selection voting method, which takes into account both the reproducibility and classification accuracy and makes a good balance between them.

FIG. 6c shows a volcano plot using the invention, the Consensus Voting Feature Selection method. The twenty selected genes are again marked in solid spots and the numbers are their corresponding ranks. No cutoff values are used. It is seen that the top features are located at the two top side-corners. The closer the spots to the origin, the lower their ranks. The selected twenty genes are both of high fold change values and low p-values, far away from the fold change cutoff lines and the p value cutoff line. This example indicates that the invention is effective at selecting reliable genes, which are of not only high reproducibility, but also classification accuracy.

### REFERENCES

[1] Anderson et al. (2004) The human plasma proteome—A nonredundant list developed by combination of four separate sources. Mol & Cell Proteomics. 3.4:311-326.
[2] Hartwell, Lee (2006) Conference Opening and Featured Lecture—The Second Annual US HUPO Conference, Boston, Mass., Mar. 11-15, 2006, as reported in “Speeding biomarker discovery,” Vol. 5 J. of Proteomic Research. 1047-48 (2006).
[3] F. P. Roth (2001) Bringing Out the Best Features of Expression Data. Genome Res. 11:1801-1802.
[4] Guyon et al. (2003) An Introduction to variable and feature selection. J of Machine learning Research. 3:1157-1182.
[5] Xiong et al. (2001) Biomarker Identification by Feature Wrapper. Genome Res. 11: 1878-1887.
[6] Monti et al. (2003) Consensus clustering: a resampling-based method for class discovery and visualization of gene expression microarray data. Machine Learning. 52:91-118.
[7] Swift et al. (2004) Consensus clustering and functional interpretation of gene-expression data. Genome Biology 5: R94, pp 1-16.
[8] Chen, D., Liu, Z., Ma, X., and Hua, D. (2005) Selecting Genes by test statistics. J Biomedicine and Biotechnology. 2:132-138.
[9] Chai H. and Domeniconi, C. (September 2004) An evaluation of gene selection methods for multi-class microarray data classification. Proceedings of the Second European Workshop on Data Mining and Text Mining in Bioinformatics., Pisa, Italy., pp 7-14.
[10] Borisov A., Eruhimov V., and Tuv, E., (2003) Boosting Flexible Learning Ensembles with Dynamic Feature Selection, NIPS 2003 workshop on feature extraction and feature selection challenge. http://clopinet.com/isabelle/Projects/NIPS2003/
[11] Boulesteix, A., Tutz, G., and Strimmer, K. (2003) A CART-based approach to discover emerging patterns in microarray data. Bioinformatics, Vol. 19(18): 2465-2472.
[12] Pavlidis, P., Weston, J., Cai, J., Grundy, W N. (2001) Gene functional classification from heterogeneous data (Draft for Publication). pp 1-11.
[13] Schena, M., Shalon, D., Heller, R., Chai, A., Brown, P., Davis, R. (1996) Parallel human genome analysis: microarray-based expression monitoring of 1000 genes. PNAS, 93:10614-10619.
[14] Tang, E., Suganthan, P N., Yao, X. (2006) Gene selection algorithms for microarray data based on least squares support vector machine. BMC Bioinformatics. 7:95.
[15] Hastie, T., Tibshirani, R., Eisen, M B., Alizadeh, A., Levy, R., Staudt, L., Chan, W C., Botstein, D., and Brown, P. (2000) ‘Gene shaving’ as a method for identifying distinct sets of genes with similar expression patterns. Genome Biology, 1(2):research0003.1-0003.21.
[16] http://en.wikipedia.org/wiki/Decision_tree_learning
[17] http://en.wikipedia.org/wiki/Kolmogorov-Smirnov_test
[18] Gilad-Bachrach, R., Navot, A., and Tishby, N. (2004) Margin based feature selection—theory and algorithms. http://www.aicml.cs.ualberta.ca/_banff04/icml/pages/papers/100.pdf
[19] Tibshirani, R., Hastie, T., Narasimhan, B., and Chu, G. (2002) Diagnosis of multiple cancer types by shrunken centroids of gene expression. PNAS. 99: 6567-6572.
[20] Nguyen, D V., Rocke, D M. (2002) Multi-class cancer classification via partial least squares with gene expression profiles. Bioinformatics Vol. 18(9), pp 1216-1226.
[21] Diaz-Uriarte, R., Alvarez de Andres, S. (Jan. 6, 2006) Gene selection and classification of microarray data using random forest. BMC Bioinformatics. 7:3.
[22] T. R. Golub, et al., (15 Oct. 1999) Molecular Classification of Cancer: Class discovery and class prediction by gene expression monitoring. Science. Vol. 286.
[23] Tusher, V., Tibshirani, R., and Chu, G. (April 2001) Significance analysis of microarrays applied to the ionizing radiation response. Proc. Natl. Acad. Sci. 98(9): 5116-5121.
[24] Guyon I., Weston J., Barnhill S. and Vapnik V. (2002) Gene selection for cancer classification using support vector machines, Machine Learning, 46:389-422.
[25] Zhang, X., Lu, X., Shi, Q., Xu, X., Leung, H. E., Harris, L., Iglehart, J., Miron, A., Liu, J., and Wong, W. (2006) Recursive SVM feature selection and sample classification for mass spectrometry and microarray data. BMC Bioinformatics. 7:197.
[26] http://en.wikipedia.org/wiki/Student%27s_t-test
[27] Wu, Z. and Li, C. (2003) Feature selection using transductive support vector machine, NIPS 2003 workshop on feature extraction and feature selection challenge. http://clopinet.com/isabelle/Projects/NIPS2003/
[28] Zhou, X., Wang, X., Dougherty, E. (2004) Nonlinear probit gene classification using mutual information and wavelet-based feature selection. Journal of Biological Systems. Vol. 12(3):371-386.
[29] http://en.wikipedia.org/wiki/Welch's_t_test
[30] http://en.wikipedia.org/wiki/Mann-Whitney_U
[31] MAQC Consortium (September 2006) The Microarray Quality Control Consortium. Nature Biotechnology. Vol. 24(9):1151-1161.

We claim:

1. A process for selecting features associated with a set of data, said process comprising the steps of:
(a) receiving said data;
(b) applying to said data K distinct processes for ranking the closeness of association of features of a common kind to data of the same kind as said received data to determine K sets, Mₖ from k=1 to K, of J ranked features each, where J is an integer greater or equal to 1 and K is an integer greater or equal to 2;
(c) consensus ranking features in the union of K sets Mₖ, for k=1 to K, according to method (process) scores and feature scores related to the ranks and the occurrence frequency of each of the J features in each set Mₖ weighted according to weights each greater than zero; and
(d) transmitting a set of said J consensus-ranked features.

2. The process of claim 1 further comprising the step of pre-processing the received data.

3. The process of claim 1 wherein the consensus ranking weight in step (c) for a feature ranked by a distinct process k is related to a method score for process k that is related to the frequency of occurrence of each of the J features and their ranks in set Mₖ across all K sets.

4. The process of claim 3 wherein the method score for said distinct process k is proportional to the sum over j=1 to J of the product of the frequency of a feature j appearing in set Mₖ appearing across all K sets and a mathematical function of the feature's reverse rank, J+1-rank, in set Mₖ.

5. The process of claim 4 wherein said mathematical function is a square root.

6. The process of claim 3 wherein the method score for said distinct process k is proportional to the sum over j=1 to J of the product of the occurrence frequency of a feature j appearing in set Mₖ appearing across all K sets and a mathematical function of the feature's rank in set Mₖ.

7. The process of claim 6 wherein the method score for said distinct process k is proportional to the sum over j=1 to J of the quotient of the occurrence frequency of a feature j appearing in set Mₖ appearing across all K sets and a mathematical function of the feature's rank in set Mₖ.

8. The process of claim 7 wherein said mathematical function is a square root.

9. The process of claim 3 wherein the consensus ranking weight in step (c) for a feature ranked by a distinct process k is the quotient of its method score and the sum of consensus process scores for all K processes.

10. The process of claim 9 wherein the feature score is proportional to the sum over k=1 to K of the product of the consensus ranking weight for process k and a mathematical function of the feature's reverse rank, J+1-rank, in set Mₖ.

11. The process of claim 10 wherein said mathematical function is a square root.

12. The process of claim 9 wherein the feature score is proportional to the sum over k=1 to K of the product of the consensus ranking weight for process k and a mathematical function of the feature's rank in set Mₖ.

13. The process of claim 12 wherein said mathematical function is a square root.

14. The process of claim 1 wherein said K processes include statistical sampling methods.

15. The process of claim 14 wherein said statistical methods include one or more of ANOVA test, B-Max, B-Min, B-scatter, Boosting Flexible Learning Ensembles with Dynamic Feature Selection, Brown Forsythe Statistic, CART, Chi Squared, Comb, Correlation Based, Fisher Score, Fold Change, Forward Substitution and Backward Elimination, Gene Shaving, Gini Impurity, Goodness-of-Fit, Information Gain, Kolmogorov-Smirnov Test, Kruskal-Wallis Test (H Test), Margin based, MinMax, Nearest Shrunken Centroid, Partial Least Square, Random Forest, Signal to Noise Ratio, Significance Analysis of Microarray (SAM), Support Vector Machine based, T test, Transductive Support Vector Machine, Wavelet-based, Welch T, Wilcoxon Rank Sum and similar methods.

16. The process of claim 14 further comprising the step of re-sampling.

17. The process of claim 14 further comprising the steps of evaluating one or more of the consensus-ranked features and displaying the evaluation.

18. The process of claim 17 wherein said evaluating comprises testing for reproducibility.

20. The process of claim 17 wherein said evaluating comprises testing for prediction accuracy.

21. The process of claim 1 wherein said features are putative biomarkers.

22. The process of claim 21 wherein said data is received to a data base facility from the output of at least one biomarker-bioactivity sensor for multiple data points.

23. Apparatus for reliably selecting features associated with a set of data comprising:
(a) a data base facility for receiving said data;
(b) one or more data processors adapted to perform K distinct processes for ranking the closeness of association of features of a common kind to data of the same kind as said received data to determine K sets, M₁ to M_{K}, of J ranked features each, where J is an integer greater or equal to 1 and K is an integer greater or equal to 2;
(c) a data processor adapted to consensus rank features in the union of sets M₁ to M_{K}, for k=1 to K, according to feature scores related to the ranks of each of the J features in each set Mₖ weighted according to weights each greater than zero; and
(d) means for outputting a representation of at least one of said consensus-ranked features.

24. The apparatus of claim 23 further comprising a data processor adapted to pre-process said data.

25. The apparatus of claim 23 wherein the consensus ranking weight in the consensus ranking processor (c) for a feature ranked by a distinct process k is related to a consensus process score for process k that is related to the frequency of occurrence of each of the J features in set Mₖ across all K sets.

26. The apparatus of claim 25 wherein the consensus process score for said distinct process k is proportional to the sum over j=1 to J of the quotient of the frequency of a feature j, appearing in set Mₖ appearing across all K sets and a mathematical function of the feature's rank in set Mₖ.

27. The apparatus of claim 26 wherein the feature score is proportional to the sum over k=1 to K of the product of the consensus score for process k and a mathematical function of the feature's rank in set Mₖ.

28. The apparatus of claim 23 wherein said K processes include statistical sampling methods.

29. The apparatus of claim 28 wherein said statistical methods include one or more of ANOVA test, B-Max, B-Min, B-scatter, Boosting Flexible Learning Ensembles with Dynamic Feature Selection, Brown Forsythe Statistic, CART, Chi Squared, Comb, Correlation Based, Fisher Score, Fold Change, Forward Substitution and Backward Elimination, Gene Shaving, Gini Impurity, Goodness-of-Fit, Information Gain, Kolmogorov-Smirnov Test, Kruskal-Wallis Test (H Test), Margin based, MinMax, Nearest Shrunken Centroid, Partial Least Square, Random Forest, Signal to Noise Ratio, Significance Analysis of Microarray (SAM), Support Vector Machine based, T test, Transductive Support Vector Machine, Wavelet-based, Welch T, Wilcoxon Rank Sum and similar methods.

30. The apparatus of claim 23 wherein said features are putative biomarkers and the apparatus is adapted to receive said data from the output of at least one biomarker-bioactivity sensor for multiple data points.

31. Computer-readable media comprising a computer-readable pattern that upon reading into a computer adapts the computer to reliably select features associated with a set of data by performing steps comprising:
(a) receiving said data;
(b) performing K distinct processes for ranking the closeness of association of features of a common kind to data of the same kind as said received data to determine K sets, M₁ to M_{K}, of J ranked features each, where J is an integer greater or equal to 1 and K is an integer greater or equal to 2;
(c) consensus ranking features in the union of sets M₁ to M_{K}, for k=1 to K, according to feature scores related to the ranks of each of the J features in each set Mₖ weighted according one or more weights each greater than zero; and
(d) transmitting a representation of at least one of said consensus-ranked features.

32. The computer-readable media of claim 31 wherein the consensus ranking weight in step (c) for a feature ranked by a distinct process k is related to a consensus process score for process k that is related to the frequency of occurrence of each of the J features in set Mₖ across all K sets.

33. The computer-readable media of claim 32 wherein the consensus process score for said distinct process k is proportional to the sum over j=1 to J of the quotient of the frequency of a feature j, appearing in set Mₖ appearing across all K sets and a mathematical function of the feature's rank in set Mₖ.

34. The computer-readable media of claim 33 wherein the feature score is proportional to the sum over k=1 to K of the product of the consensus score for process k and a mathematical function of the feature's rank in set Mₖ.

35. The computer-readable media of claim 31 wherein said K processes include statistical sampling methods.

36. The computer-readable media of claim 31 wherein said step of performing K processes include calling to statistical analytic software routines including one or more of ANOVA test, B-Max, B-Min, B-scatter, Boosting Flexible Learning Ensembles with Dynamic Feature Selection, Brown Forsythe Statistic, CART, Chi Squared, Comb, Correlation Based, Fisher Score, Fold Change, Forward Substitution and Backward Elimination, Gene Shaving, Gini Impurity, Goodness-of-Fit, Information Gain, Kolmogorov-Smirnov Test, Kruskal-Wallis Test (H Test), Margin based, MinMax, Nearest Shrunken Centroid, Partial Least Square, Random Forest, Signal to Noise Ratio, Significance Analysis of Microarray (SAM), Support Vector Machine based, T test, Transductive Support Vector Machine, Wavelet-based, Welch T, Wilcoxon Rank Sum and similar methods.

37. The computer-readable media of claim 31 wherein said features are putative biomarkers and the computer-read pattern further adapts the computer to receive said data from the output of at least one biomarker-bioactivity sensor for multiple data points.
